(19) United States
(12) Patent Application Publication
(10) Pub. No.: US 2021/0400948 A1
(43) Pub. Date: Dec. 30, 2021

(54) ANIMAL TRAP

(71) Applicant: James A. Nunez, Naples, FL (US)

(72) Inventor: James A. Nunez, Naples, FL (US)

(21) Appl. No.: 16/914,746

(22) Filed: Jun. 29, 2020

(51) Int. Cl. A01M 23/18

(52) U.S. Cl. CPC A01M 23/18; A01M 2200/00

(57) ABSTRACT

An animal trap (1) that provides ramped entryways for cane toads to pass through and a hands-free touchless method of disposing of cane toads captured in the animal trap that allows individuals to empty the animal trap without coming into contact with captured cane toads and/or the poison the captured cane toads secrete.

### FIELD OF THE INVENTION

This invention relates to traps used for capturing small animals and more particularly an animal trap designed for capturing and touchless disposal of cane toads.

### BACKGROUND OF THE INVENTION

The cane toad (Bufo marinus) has been introduced to many regions of the world as a method of agricultural pest control. However instead of controlling pests, cane toads became a pest and are now considered an invasive species in many countries as they pose threats to many small animals due to their poisonous secretions.

When a cane toad is threatened, its glands secrete a milky-white fluid that is toxic to many animals. Dogs are especially prone to being poisoned by licking or biting toads they come across in their yards. Resulting poisoning symptoms include excessive drooling, extremely red gums, head-shaking, crying, loss of coordination, and/or convulsions that often result in death.

There have been attempts to reduce the cane toad population by having live hunts conducted at night wherein one or more individuals search for and capture cane toads by hand. Cane toads normally hide under shrubs and/or by shallowly burrowing in the ground. This makes them difficult to spot at night meaning many cane toads can go missed during a live hunt, Thus, live hunts need to be carried out on a reoccurring basis to keep a cane toad population at bay. However, many individuals do not want to come into contact with a cane toad so performing a live hunt is out of the question.

Alternatively, many have turned to conventional metal, cages with one-way swinging trapdoors to as a method of capturing cane toads. However, cane toads have tendency to drag debris, such as leaves and mulch, that ends up becoming caught in the conventional swinging trapdoor. The caught debris props the trapdoor in an open position thereby allowing the opportunity for one or more captured cane toads to escape from the cage.

An additional drawback of conventional cages is a raised lip located below the swinging trapdoor. The raised lip can prevent and/or deter cane toads from entering the cage.

An added concern is the challenge of emptying conventional cages, which must be performed by hand. Emptying toads from a conventional cage by hand is a challenge for most individuals regardless of danger of coining into contact with a cane toad's poison.

Therefore, a need exists for an animal trap that provides an easy entryway for cane toads to enter through wherein debris is prevented from becoming trapped between the entryway and the trapdoor. In addition, a need exists for an animal trap wherein the structure of the animal trap provides for a hands-free method of touchless disposal of cane toads captured in the animal trap.

### SUMMARY OF THE INVENTION

The primary object of the present invention is to provide an animal trap that provides an easy entryway for cane toads wherein a ramp leading into the entryway allows cane toads to enter the animal trap without any impediments.

An additional object of the present invention is to provide an animal trap that prevents debris from becoming trapped between the entryway and the trapdoor by providing a ramp that provides a drop-off for causing a cane toad and debris attached to the cane toad to fall into the animal trap.

A further object of the present invention is to provide an animal trap wherein the structure of the animal trap provides for a hands-free touchless method of disposing of cane toads captured in the animal trap.

An additional object of the present invention is to provide a hands-free touchless method of disposing of untargeted captures, such as rats or snakes, captured in the animal trap.

A further object of the present invention is to provide an animal trap wherein a housing of the animal trap that is preferably constructed out of plastic to provide a smooth inner surface that will not unnecessarily injure captured animals as a conventional metal cage often will.

An additional object of the present invention is to provide an animal trap that eliminates the need for poisons and chemicals to control the cane toad population.

The present invention fulfills the above and other objects by providing an animal trap designed specifically for capturing and disposing of cane toads. The animal trap has a substantially box-shaped housing having a roof, floor, sidewalls, a frontend and a backend.

An entryway is located on the frontend and/or backend of the housing and is defined by an upper edge, a lower edge and side edges. A trapdoor is hingedly attached to the upper edge of the entryway to allow the trapdoor to swing into open and closed positions in relation to the entryway. The trapdoor is capable of swinging inward into the housing of the cage to allow cane toads to enter the housing, however, the trapdoor is prevented from swinging outward by a ramp located on the bottom edge of the entryway and or other stop. The trapdoor may have multiple panels or sections that each pivot independently, thereby reducing the amount of pressure a toad must exert to enter the animal trap.

The ramp partially covers a lower portion of the entry way while transitioning at an angle downward toward the exterior of the animal trap to provide an angled surface for a cane toad to climb through the entryway. As the cane toad passes through the entryway, the cane toad will fall off the ramp into the housing along with any debris the cane toad is dragging with it, thereby clearing the entryway.

The ramp may also extend into the interior of the animal trap a predetermined distance, thereby causing the trapdoor to be angled inward in relation to the entryway when the trapdoor is in a closed position.

In addition, an attachment for securing waste bags to the animal trap is provided. A waste bag may be secured to the cage over an entryway or other covered opening. The animal trap may then be inverted over the waste bag. A release allows the trapdoor to be raised upward to clear the ramp so that the trap door will swing outward as the animal trap is turned upside down, thereby allowing any captures toads to fall into the bag. After the contents of the animal trap have fallen into the waste bag, it may be detached from the animal trap and disposed of.

Attractants, such as, light, sound, heat, odors and so forth may be used to attract cane toads to the animal trap and to entice them to enter the animal trap.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side and front perspective view of an animal trap of the present invention;

FIG. 2 is a sectional view along lines A-A of FIG. 1 of an animal trap of the present invention;

FIG. 3 is a front view of an animal trap of the present invention;

FIG. 4 is a rear view of an animal trap of the present invention;

FIG. 5 is a right side view of an animal trap of the present invention;

FIG. 6 is a left side view of an animal trap of the present invention;

FIG. 7 is a top view of an animal trap of the present invention;

FIG. 8 is a bottom view of an animal trap of the present invention;

### DESCRIPTION OF THE PREFERRED EMBODIMENTS

For purposes of describing the preferred embodiment, the terminology used in reference to the numbered accessories in the drawings is as follows:
1. animal trap, generally
2. housing
3. frontend of housing
4. backend of housing
5. roof
6. floor
7a. right sidewall of housing
7b. left sidewall of housing
7. front entryway
8. upper edge of front entryway
9. lower edge of front entryway
10. right side edge of front entryway
11. left side edge of front entryway
12. front trapdoor
13. front ramp
14. back entryway
15. upper edge of back entryway
16. lower edge of back entryway
17. right side edge of back entryway
18. left side edge of back entryway
19. back trapdoor
20. back ramp
21. attachment means for waste bag
22. hook
23. release
24. stud
25. curved slot

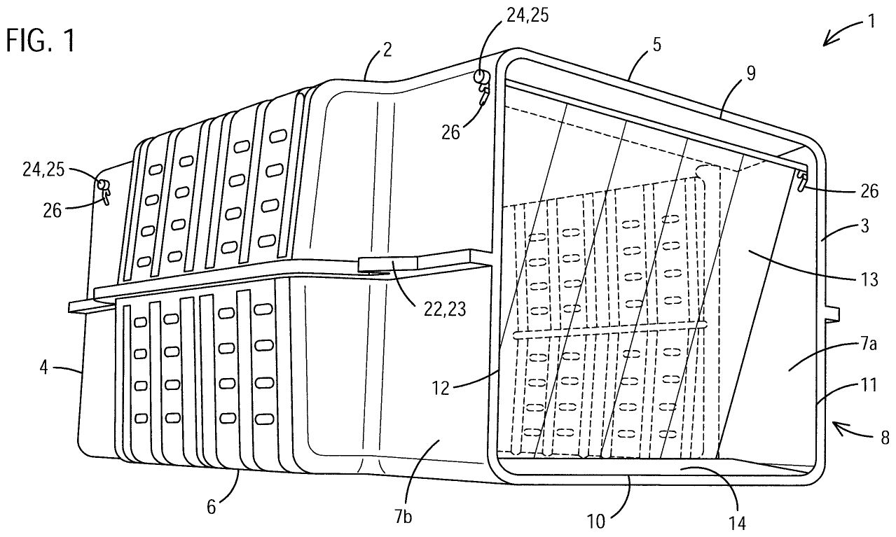

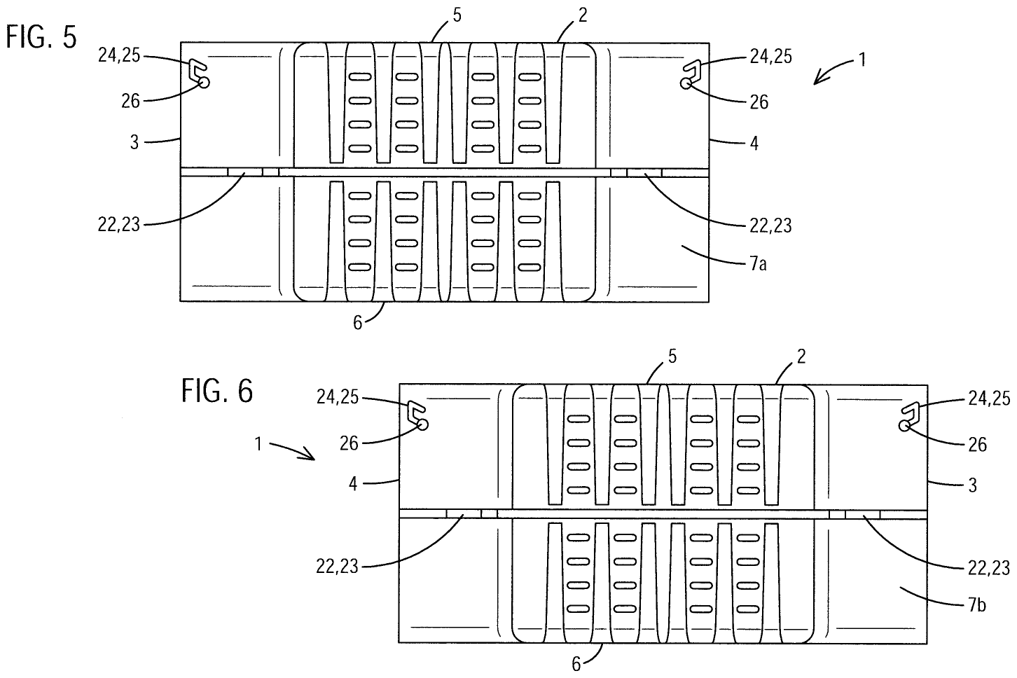

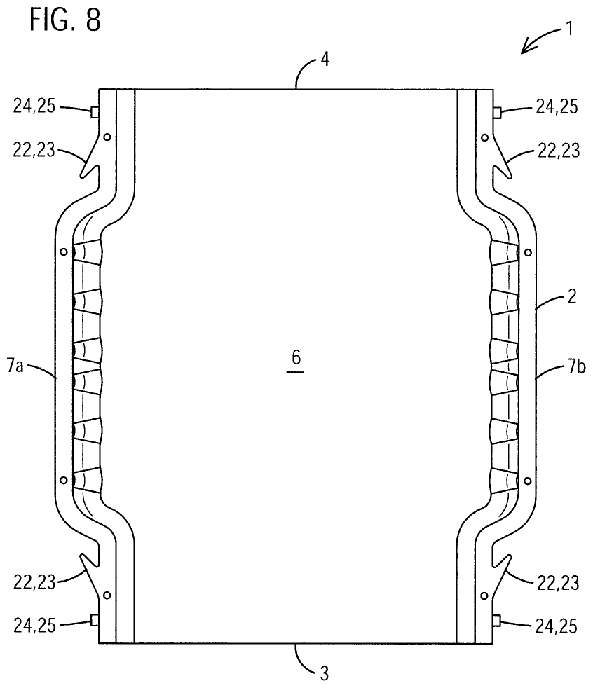

With reference to FIGS. 1-8, various views of an animal trap 1 designed specifically for capturing and touchless disposal of cane toads is illustrated. The animal trap 1 comprises a substantially box-shaped housing 2 having a frontend 3, a backend 4, a roof 5, a floor 6, a right sidewall 7a, and a left sidewall 7b.

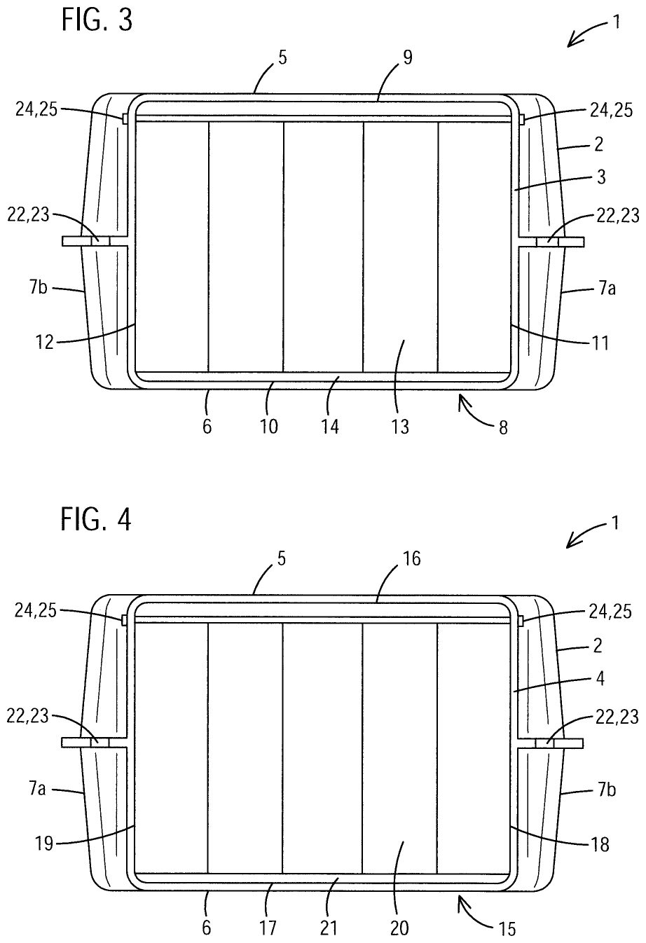

An entryway 7 is located on the frontend 3 and/or the backend 4 of the housing 2. As illustrated in FIG. 3, a front entryway 8 is located on the frontend 3 of the housing 2. The front entryway 8 comprises an upper edge 9, a lower edge 10, a right side edge 11 and a left side edge 12.

A front trapdoor 13 is hingedly attached to the upper edge 9 of the front entryway 8 to allow the front trapdoor 13 to swing into open and closed positions in relation to the front entryway 8. The front trap 13 door is capable of swinging inward into the housing 2 to allow cane toads to enter the housing 2. However, the front trapdoor 13 is prevented from swinging outward by a projection or preferably a front ramp 14 located on the lower edge 10 of the front entryway 8 and/or other stop.

The front ramp 14 partially covers a lower portion of the front entryway 8 while transitioning at an angle downward to provide an angled surface for a cane toad to climb through the front entryway 8.

As illustrated in FIG. 4, a back entryway 15 is located on the backend 4 of the housing 2. The back entryway 15 comprises an upper edge 16, a lower edge 17, a right side edge 18 and a left side edge 19.

A back trapdoor 20 is hingedly attached to the upper edge 16 of the back entryway 15 to allow the back trapdoor 20 to swing into open and closed positions in relation to the back entryway 15. The back trapdoor 20 is capable of swinging inward into the housing 2 to allow cane toads to enter the housing 2. However, the back trapdoor 20 is prevented from swinging outward by a projection or preferably a back ramp 21 located on the lower edge 17 of the back entryway 15 and/or other stop.

The back ramp 21 partially covers a lower portion of the back entryway 15 while transitioning at an angle downward to provide an angled surface for a cane toad to climb through the back entryway 15.

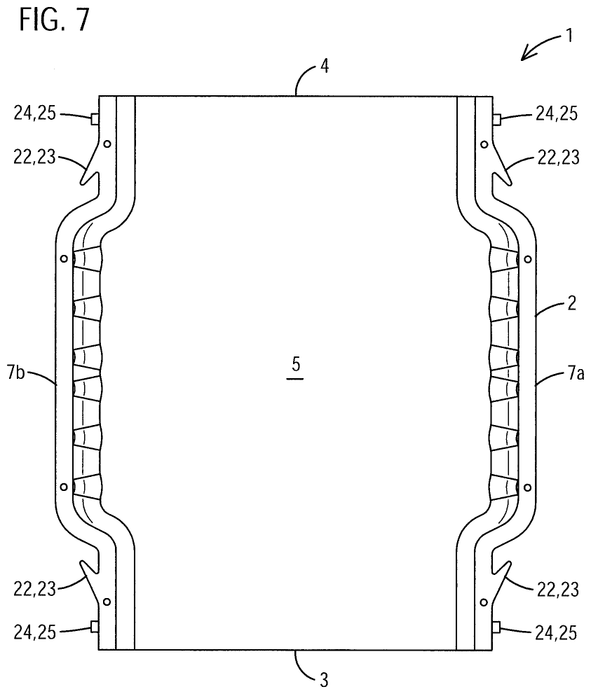

At least one attachment means 22, such as a hook 23, clip, clamp, and so forth, used for securing a waste bag to the animal trap 1 is preferably located on an outer surface of the housing 2. A waste bag may be secured to the animal trap 1 over the front entryway 8, back entryway 15 or other covered opening wherein at least one attachment means 22 is adjacent thereto. As illustrated in FIG. 7, attachment means 22 comprises hooks 23 located adjacent to the front entryway 8.

After a waste bag is attached to the housing 2 using the hooks 23, the animal trap 1 may be inverted over the waste bag, thereby dumping any captured kane toads into the waste bag, which may then be sealed and detached from the animal trap 1.

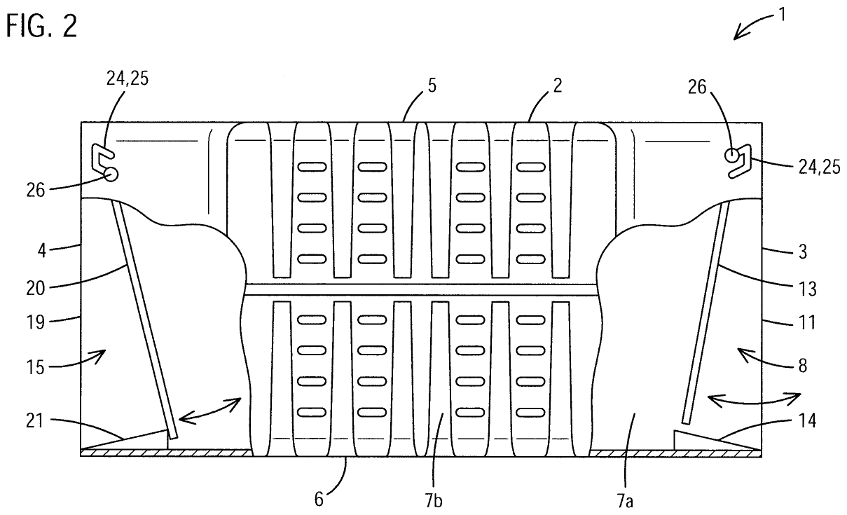

The front trapdoor 13 and/or rear trapdoor 20 may be place into open positions to allow captured cane toads to fall out of the animal trap 1 and into an attached waste bag. As illustrated in FIG. 2 one or more releases 24 are provided to allow the front trapdoor 13 and/or rear trapdoor 20 to open outward when the animal trap 1 is inverted. As illustrated herein, the release 24 comprises studs 25 that extend through curved slots 26 on the housing 2, The curved slots 26 provides a step system to raise and lower the front trapdoor 13 and/or rear trapdoor 20 so the front trapdoor 13 and/or rear trapdoor 20 will clear the front ramp 14 and/or back ramp 21, respectively, and swing outward into the attached waste bag, thereby allowing any captured cane toads to fall into the attached waste bag.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. An animal trap comprising:
a housing having a frontend, a backend, a roof, a floor, a right sidewall, and a left sidewall;
a front entryway located on the frontend of the housing;
said front entryway comprising an upper edge, a lower edge, a right, side edge and a left side edge;
a front trapdoor hingedly attached to the upper edge of the front entryway to allow the front trapdoor to swing into open and closed positions in relation to the front entryway;
a front ramp located on the lower edge of the front entryway; and
said front ramp partially covering a lower portion of the front entryway to prevent the front trapdoor from swinging outward out of the housing.

2. The animal trap of claim 1 further comprising:
a back entryway located on the backend of the housing;
said back entryway comprising an upper edge, a lower edge, a right side edge and a left side edge;
a back trapdoor hingedly attached to the upper edge of the back entryway to allow the back trapdoor to swing into open and closed positions in relation to the back entryway;
a back ramp located on the lower edge of the back entryway; and
said back ramp partially covering a lower portion of the back entryway to prevent the back trapdoor from swinging outward out of the housing.

3. The animal trap of claim 1 further comprising:
at least one attachment means for securing a waste bag to the animal trap over the front entryway.

4. The animal trap of claim 3 wherein:
said at least one attachment means for securing a waste bag to the animal trap over the front entryway is at least one hook.

5. The animal trap of claim 2 further comprising:
at least one attachment means for securing a waste bag to the animal trap over the back entryway.

6. The animal trap of claim 4 wherein:
said at least one attachment means for securing a waste bag to the animal trap over the back entryway is at least one hook.

7. The animal trap of claim 1 further comprising:
at least one release located between the housing and the front trapdoor to allow the front trapdoor to open outward when the animal trap is inverted.

8. The animal trap of claim 3 further comprising:
at least one release located between the housing and the front trapdoor to allow the front trapdoor to open outward when the animal trap is inverted.

9. The animal trap of claim 2 further comprising:
at least one release located between the housing and the back trapdoor to allow the back trapdoor to open outward when the animal trap is inverted.

10. The animal trap of claim 5 further comprising:
at least one release located between the housing and the back trapdoor to allow the back trapdoor to open outward when the animal trap is inverted.

11. An animal trap comprising:
a housing having a frontend, a backend, a roof, a floor, a right sidewall, and a left sidewall;
a front entryway located on the frontend of the housing;
said front entryway comprising an upper edge, a lower edge, a right side edge and a left side edge;
a front trapdoor hingedly attached to the upper edge of the front entryway to allow the front trapdoor to swing into open and closed positions in relation to the front entryway; and
at least one attachment means for securing a waste bag to the animal trap over the front entryway.

11. The animal trap of claim 10 further comprising:
a back entryway located on the backend of the housing;
said back entryway comprising an upper edge, a lower edge, a right side edge and a left side edge;
a back trapdoor hingedly attached to the upper edge of the back entryway to allow the back trapdoor to swing into open and closed positions in relation to the back entryway; and
at least one attachment means for securing a waste bag to the animal trap over the front entryway.

12. The animal trap of claim 10 further comprising:
a front ramp located on the lower edge of the front entryway; and
said front ramp partially covering a lower portion of the front entryway to prevent the front trapdoor from swinging outward out of the housing.

13. The animal trap of claim 11 further comprising:
a back ramp located on the lower edge of the back entryway; and
said back ramp partially covering a lower portion of the back entryway to prevent the back trapdoor from swinging outward out of the housing.

14. The animal trap of claim 10 wherein:
said at least one attachment means for securing a waste bag to the animal trap over the front entryway is at least one hook.

15. The animal trap of claim 11 wherein:
said at least one attachment means for securing a waste bag to the animal trap over the back entryway is at least one hook.

16. The animal trap of claim 10 further comprising:
at least one release located between the housing and the front trapdoor to allow the front trapdoor to open outward when the animal trap is inverted.

17. The animal trap of claim 12 further comprising:
at least one release located between the housing and the front trapdoor to allow the front trapdoor to open outward when the animal trap is inverted.

18. The animal trap of claim 11 further comprising:
at least one release located between the housing and the back trapdoor to allow the back trapdoor to open outward when the animal trap is inverted.

19. The animal trap of claim 13 further comprising:
at least one release located between the housing and the back trapdoor to allow the back trapdoor to open outward when the animal trap is inverted.

20. An animal trap comprising:
a housing having a frontend, a backend, a roof, a floor, a right sidewall, and a left sidewall;
a front entryway located on the frontend of the housing;
said front entryway comprising an upper edge, a lower edge, a right side edge and a left side edge;
a front trapdoor hingedly attached to the upper edge of the front entryway to allow the front trapdoor to swing into open and closed positions in relation to the front entryway; and
at least one release located between the housing and the front trapdoor to allow the front trapdoor to open outward when the animal trap is inverted.
